(19) United States
(12) Patent Application Publication
(10) Pub. No.: US 2017/0052532 A1
(43) Pub. Date: Feb. 23, 2017

(54) SYSTEM FOR CONTROLLING, MONITORING AND REGULATING PROCESSES IN INDUSTRIAL PLANTS AND A METHOD FOR OPERATING SUCH A SYSTEM

(71) Applicant: SIEMENS AKTIENGESELLSCHAFT, Munchen (DE)

(72) Inventors: Michael Adler, Nuernberg (DE); ROLAND BRILL, Erlangen (DE)

(73) Assignee: SIEMENS AKTIENGESELLSCHAFT, Munchen (DE)

(21) Appl. No.: 15/241,934

(22) Filed: Aug. 19, 2016

(30) Foreign Application Priority Data
Aug. 20, 2015 (EP) 15181755.8

(51) Int. Cl. G05B 19/418

(52) U.S. Cl. CPC G05B 19/418; G05B 2219/32015

(57) ABSTRACT

A system for controlling, monitoring and regulating a process in an industrial plant includes a closed feedback loop which includes an automatically configurable central data acquisition for acquiring an operating parameter generated by the industrial plant on a customer side in a field, and a central data evaluation unit. The central data evaluation unit includes a centralized data collecting unit, a generating module configured to generate a result for plant optimization, process extension, optimization of necessary maintenance works, or any combination thereof, and a creation module configured to create a new target parameter via automated adaptation of the operating parameter. A first communication connection transmits data from the field to the central data evaluation unit, and a second communication connection transmits data in response to the target parameter from the central data evaluation unit back to the field and adjusts the industrial plant as a function of the target parameter.

### CROSS-REFERENCES TO RELATED APPLICATIONS

This application claims the priority of German Patent Application, Serial No., 15181755.8 filed, Aug. 20, 2015 pursuant to 35 U.S.C. 119(a)-(d), the disclosure of which is incorporated herein by reference in its entirety as if fully set forth herein.

### BACKGROUND OF THE INVENTION

The present invention relates to a system for controlling, monitoring and regulating processes in industrial plants, and to a method for operating such a system.

The following discussion of related art is provided to assist the reader in understanding the advantages of the invention, and is not to be construed as an admission that this related art is prior art to this invention.

For industrial plants for the production or processing of goods or energy, there has long been a need for a guidance system which enables optimum and in particular economical guidance of the process carried out in the plant. Conventionally, this need has been taken into account sub-optimally by installations of the conventional control technology where possible. Particularly in production processes which entail great control technology problems, however, the control technology effort necessary increases enormously without the result achieved being truly satisfactory.

Devices which run productively every day in the plants of customers are very often not optimally adjusted. Thus an optimum of availability, productivity and resource efficiency can barely be achieved. The availability can be increased in that outage times due, for example, to material wear are prevented. This can be achieved, for example, in that the devices are only operated under known optimum conditions (e.g. daily operating hours, maximum rotary speed, optimum temperature).

Productivity can be increased in that necessary maintenance works, for example, the exchange of worn parts is planned for times when the machine or plant would anyway not be operating. This is essentially during works closures, at the weekend and during the night. It is herein essential to know when a machine must be serviced, based on the actual operating hours and the operation type. A classical service at fixed service intervals typically takes place more frequently than is technically necessary. In this way, the manufacturer is on the safe side.

Resource efficiency can be enhanced in that, for example, operations are optimized, less material is used and less energy is used. The latter can be achieved, for example, in that detailed information concerning energy costs, anticipated expected daily running times of the machines is combined in order thereby to distribute the energy consumption over the day and to avoid expensive load peaks.

Historic and current measurement data of the machines from the field can provide relevant information regarding developments and future events in the aforementioned scenarios, for example, data concerning bearing heating of a machine, a traction axis, etc., can indicate, given a known loading, a future failure or can help to optimize maintenance intervals. The earlier and the closer to the customer, that is, at the site of the occurrence that these facts are present as information, the better that action can be taken pro-actively, i.e. before the event of failure or damage. In addition, a broad database from other plants with similar configurations permits conclusions to be drawn for optimizations and thus for known information to be transferred into concrete changes to the machine configuration, which positively influence the aforementioned qualities.

Such mechanisms are today operated in manual or partially automated optimization processes. However, a fully automated parameterization of the plant, i.e. the machines, on the basis of automatic data analyses across many installations, does not yet exist.

Previously, existing plants have been optimized in manual processes, if at all. For this purpose, an analysis can be carried out on site, from which an advisory report results. Measures are decided upon and implemented. This process is long-winded and is based mainly on empirical information and takes account of the analysis of other installations, at most partially. The state of the art is herein a manual acquisition of statistics regarding plant operating times, outage times, material usage and energy use. Although these analyses are based on statistical data, they are still only manual.

It would therefore be desirable and advantageous to provide an improved system for a fully automatic parameterization of industrial plants and to obviate prior art shortcomings.

### SUMMARY OF THE INVENTION

According to one aspect of the present invention, a system for controlling, monitoring and regulating a process in an industrial plant includes a closed feedback loop which includes an automatically configurable central data acquisition for acquiring an operating parameter generated by the industrial plant on a customer side in a field, a central data evaluation unit including at least one centralized data collecting unit, at least one generating module configured to generate a result for plant optimization, process extension, optimization of necessary maintenance works, or any combination thereof, and at least one creation module configured to creating a new target parameter via automated adaptation of the operating parameter, a first communication connection for transmitting data from the field to the central data evaluation unit, and a second communication connection for transmitting data in response to the target parameter from the central data evaluation unit back to the field and for adjusting the industrial plant as a function of the target parameter.

The data collecting unit may hereby be configured as a big data collecting unit and/or at least one statistical data evaluation module

According to another aspect of the present invention, a method for operating a system for controlling, monitoring and regulating a process in an industrial plant, includes establishing a closed feedback loop which includes acquiring data via an automatically configurable central data acquisition of an operating parameter generated by the industrial plant on a customer side in a field, connecting the field to a central data evaluation unit for transmitting data via a first communication connection, collecting and evaluating the data in the central data evaluation unit via at least one centralized data collecting unit, generating a result for plant optimization, process extension, optimization of necessary maintenance works, or any combination thereof, using at least one generating tool in the central data evaluation unit, creating a new target parameter through automated adaptation of the operating parameter via at least one creation module in the central data evaluation unit, and transmitting the new target parameter via a second communication connection from the central data evaluation unit back to the field for adjusting the industrial plant as a function of the target parameter.

The term “field” can be used to relate to a field on site, i.e. the central unit is located on the industrial site of the plant operator (on-premise). However, the central unit can also be installed outside the industrial site of the plant operator (e.g. cloud-based systems).

It has been discovered that ever more devices are able to provide data via their sensors which can then be collected into large databases and analyzed automatically by algorithms. In this setting, there is a broad market of big data analysis platforms. However, all these platforms and products provide the analysis results essentially only in the form of reports—partially interactively on a PC, partially in the form of documents. Decisions are made by humans and automatic processes which process the analysis results and bring them directly into the production are not yet established and available. Changes to the machines and plants are still carried out manually.

This is now avoided in accordance with the present invention. The system and the method for operating this system include in accordance with the present invention a closed feedback loop. It is thus possible to use the findings obtained from the big data analyses for optimizing already installed devices and the system in the field without the need to exchange devices on site or having to accept long manual processes.

The optimization of a single device/system takes place automatically with as little manual intervention as possible and on the basis of the findings on the broad statistical basis of many systems. Completed optimizations also take effect on site even if the first and/or second communication connection is temporarily not available because they are lastingly implemented in the field.

The automation of such machine configurations by the system according to the invention and the method according to the invention avoids a significant effort for engineering, fine adjustment, testing and roll-out in the plants. What is at the root of the matter is the bringing of decisions rapidly and unaltered into the field, always keeping them up-to-date and avoiding long-winded manual operations for the implementation. The automation has different commercially relevant effects. These are firstly the sparing of engineering for the changes, an earlier use of optimization and the possibility of always keeping resource utilization and efficiency optimal. Secondly, the maintenance time windows and outage times are optimized and human errors on readjustment are avoided.

It should be noted that the second communication connection and the first communication connection can be configured as a single connection which functions in both directions.

According to another advantageous feature of the present invention, the data acquisition can include a data pre-compression. The data acquisition can also include a data filtration. The data acquisition, the data pre-compression and the data filtration can be realized by using data collecting agents. As a result, the subsequent analysis of the data can be split. This can thus take place at least partially as pre-processing in the field, as well as in the subsequent data evaluation unit.

According to another advantageous feature of the present invention, the first communication connection can be provided at the customer, in particular at the customer on site, or via the Internet. This can be, for example, a remote service platform or can take place via a GSM/UMTS/LTE mobile radio connection. Other techniques are also possible.

According to an advantageous feature of the present invention, the creation module includes a decision tool configured to generate a first decision concerning an automated or manual generation of a maintenance order for maintenance work, or to generate a second decision concerning an automated or manual generation of a modified target parameter, with the system further including a maintenance tool and a configuration tool which are provided downstream of the decision tool, with the first decision being fed to the maintenance tool and the second decision being fed to the configuration tool. Advantageously, a plant model may be provided for automated or manual generation of the modified target parameters. The plant model contains the information regarding the plant configuration.

Thus, the decision tool makes the decisions for the target plants following the reading-in of the results. From the analyzed results, these decisions must be derived for the concrete plants, plant portions or individual machines. This takes place on the basis of rules which determine which decisions the decision tool can make automatically and which require a manual confirmation by the plant operator. This protection is necessary in order, if required, to be able to monitor excessive interventions. The decisions also require a detailed knowledge of the state of the plant configuration. A complete plant model, also known as a machine model, must therefore exist.

Essentially two decision types are distinguished. The first decision for generating orders for maintenance works which are fed to the maintenance tool and the second decision for generating and feeding in amended machine configurations which are fed to a configuration tool.

According to another advantageous feature of the present invention, the maintenance tool can include at least one first subtool configured to generate the maintenance order, and a second maintenance subtool placed downstream of the first maintenance subtool configured to plan and issue the maintenance order. For this purpose, in the first maintenance subtool, some interfaces to other systems are necessary in order, for example, to set corresponding items, to administer orders and tickets, etc. In the second maintenance subtool, in turn, interfaces to other systems are used in order to issue maintenance orders. For this purpose, detailed knowledge of the operating times of the target plant is necessary in order to achieve optimum usage planning with minimal outage times.

According to another advantageous object of the present invention, the configuration tool can include at least one generation regulation for a plant machine in the industrial plant.

According to another advantageous feature of the present invention, can include at least one first configuration subtool configured to generate the target parameter as a function of the generation regulation.

According to another advantageous feature of the present invention, the configuration tool can include a second configuration subtool, with the second configuration subtool configured to include a previously defined validation rule to enable validation of the target parameter. In this way, the validation rules can be used to validate target parameters, i.e. the target configuration. On the basis of the already existing plant configuration, a target configuration specific to each target plant is now generated. This step is technically demanding since an automated engineering must be possible for each target plant. This requires knowledge of corresponding generation regulations, e.g. the exact format and data model of the configuration suited to each target plant or the target device to be controlled in the target plant. In order to avoid combinations of machine configuration that are inconsistent or dangerous for goods and humans, the result generated must be validated. This step requires detailed validation rules that have been set in advance. At this point, evidence is provided by means of models and simulations that, for example, plant safety is assured. Herein, norms and guidelines of the respective plant operator play a role.

According to another advantageous feature of the present invention, the configuration tool can include a configuration connection for loading the validated target parameter into a target plant. This can also be the second communication connection. Following adoption of the new target parameters or target configuration, the target plant or the respective device of the target plant confirms the procedure in such a manner that it can be reliably checked that the planned change has taken place successfully and has not been changed on the way. If all is in order, the new configuration flows back into the plant model.

According to another advantageous feature of the present invention, a confirmation connection can be provided to transmit a confirmation about an adoption of the target parameter by the target plant. This confirmation can be transmitted, for example, to the central data evaluation unit or to the operator, for example, by smartphone or to a higher-order guidance system, etc.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a system for controlling, monitoring and regulating processes in industrial plants in accordance with the invention; and

FIG. 2 is a schematic illustration of a decision tool of the system according to the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

With the “big data” approach, the data is brought together in large quantities from customers/sites which are as small as possible and over as many application cases as possible. Correlations are subsequently sought in the overall database and corresponding decision and optimization information is generated. Findings from this information flow into future products or can be passed on as a service to specific customers. The machines/plants installed according to the prior art in the field are at best manually adjusted.

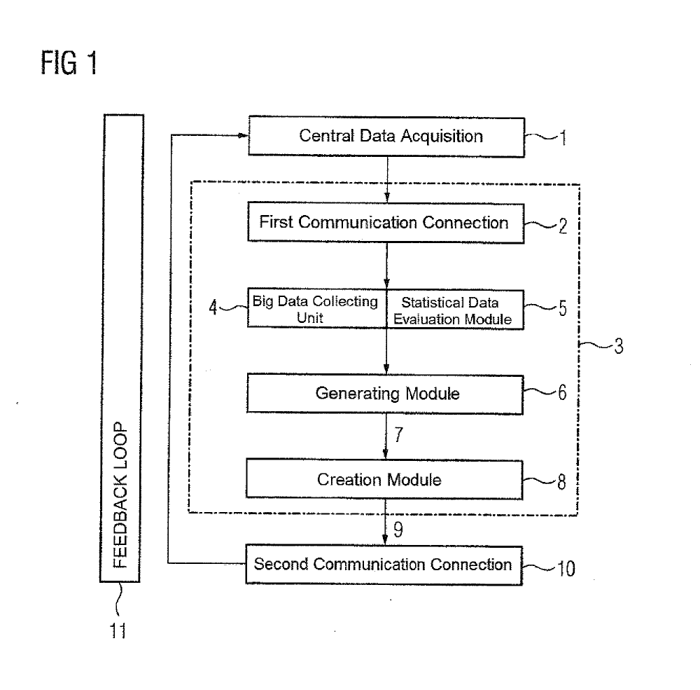

This is now avoided by means of the invention. Turning now to the drawing, and in particular to FIG. 1, there is shown a schematic illustration of a system for controlling, monitoring and regulating processes in industrial plants in accordance with the invention. The system includes a feedback loop 11 which includes an automatically configurable central data acquisition/pre-compression/filtration 1 for acquiring the operating parameters generated by the industrial plants on the customer side on site in the field. This can be realized with the aid of various data collecting agents. The analysis of the data can thus be split and can thus also take place partially as pre-processing in the field.

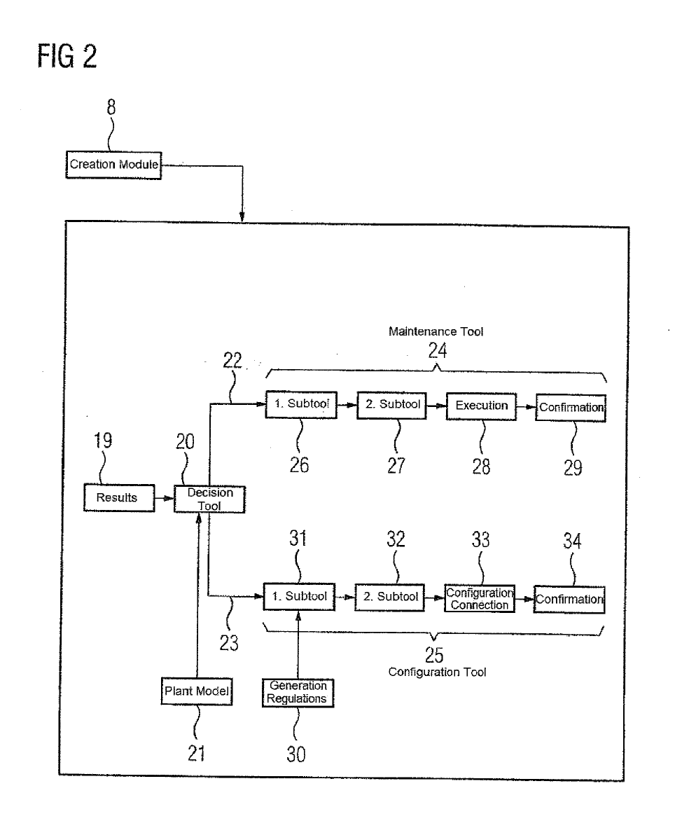

This data is transferred via a first connection 2 which extends from the field on site to the central data evaluation unit 3. The term “on site in the field” relates hereby to a location of the central unit on the industrial site of the plant operator (on-premise). However, the central unit can also be situated outside the industrial site of the plant operator (e.g. cloud-based systems). The central data evaluation unit 3 includes at least one centralized big data collecting unit 4 and a statistical data evaluation module 5 of the data. The first communication connection 2 can be realized therefor via a GSM/UMTS/LTE mobile radio connection and other established techniques. In the centralized big data collecting unit 4 and the statistical data evaluation module 5, an optimization/extension of the prognoses is undertaken. A generating module 6 is also provided in the central data evaluation unit 3 for generating results 7 for the plant optimization/process extension and/or optimization of necessary maintenance works. This is effectively a system for generating recommendations for the plant optimization or for necessary maintenance works. Furthermore, the central data evaluation unit 3 includes at least one creation module 8 for creating new target parameters 9 through automated adaptation of the operating parameters on the basis of the previous results 7. This corresponds to an automated adaptation of the operating parameters or the data acquisition/pre-compression/filtration 1 on the basis of the previous results 7. This is disclosed more precisely in FIG. 2. Additionally, a second communication connection 10 from the central data evaluation 3 back into the field is provided for transmitting and for adjusting the industrial plants with the target parameters 9.

The overall system therefore contains the closed feedback loop 11 as an optimization loop. It is thus possible to use the findings and results 7 obtained from the big data analyses for optimizing already installed devices and the system in the field without the need to exchange devices on site or having to accept long manual processes. The optimization of the single device/system takes place automatically with as little manual intervention as possible and on the basis of the findings and results 7 of the broad statistical evaluation. Completed optimizations also take hold on site even if the first 2 and/or second 10 communication connection is temporarily not available because they are lastingly implemented in the field.

The aforementioned feedback loop 11 can be realized as a pure software component.

The essential step of the creation module 8 of new target parameters 9 using automated adaptation of the operating parameters on the basis of the results 7 by means of which the closed control loop can be generated will now be described in greater detail with reference to FIG. 2.

Each step in this process chain is a technical feature (component) which together represent the solution of the problem:

From the analyzed results 7, decisions must be derived for the actual plants, plant portions or individual machines. For this purpose, the creation module 8 must now make decisions for target plants.

The creation module 8 initially reads in the results 7 (FIG. 1) at 19. The creation module 8 also includes a decision tool 20. In the decision tool 20, either a first decision 22 is made concerning an automated or manual generation of orders for maintenance works or a second decision 23 is made concerning an automated or manual generation of modified target parameters 9 (FIG. 1). This takes place on the basis of rules which determine which decisions the system can make automatically and which require a manual confirmation of the plant operator. This protection is necessary in order, if required, to be able to monitor excessive interventions. The decisions 22, 23 also require a detailed knowledge of the state of the plant configuration—a complete plant model 21, also known as a machine model, must therefore exist. This plant model 21 is fed to the decision tool 20.

Essentially therefore, two decision types are distinguished:
the creation of orders for maintenance works (e.g. the exchange of worn parts),
the creation and application of amended target parameters 9.

A maintenance tool 24 and a configuration tool 25 are connected downstream of the decision tool 20, wherein the first decisions 22 are fed to the maintenance tool 24 and the second decisions 23 are fed to the configuration tool 25.

The maintenance tool 24 includes a first maintenance subtool 26 to which the first decision 22 is now fed. The maintenance orders are generated in the first maintenance subtool 26. Some interfaces to other systems are necessary in order, for example, to adjust suitable items and to administer orders and tickets, etc. in an inventory control system.

A second maintenance subtool 27 in which the now generated maintenance orders can be planned and issued is connected downstream of the first maintenance subtool 26. Again interfaces to other systems are used in order to issue these maintenance orders. For this purpose, detailed knowledge of the operating times of the target plant is necessary in order to achieve optimum usage planning with minimal outage times. The subsequent execution or implementation 28 of the work operations, which may optionally also carried out manually, is then achieved by humans (service engineers). Following the execution of the work, a confirmation is made by the service engineer, i.e. following the execution 28, a confirmation 29 takes place which reports back the completion into the system.

When a second decision 23 is made by the decision tool 20, this decision 23 is fed to a first configuration subtool 31. This contains at least one generation regulation 30 for plant machines provided in the industrial plant. Thus, in the first configuration subtool 31, the plant configuration is generated by means of the target parameters 9 (FIG. 1). On the basis of the already existing plant configuration, specific target parameters 9 (FIG. 1) or a target configuration are now generated for each target plant. This step is technically demanding since an automated engineering must be possible for each target plant. This requires knowledge of corresponding generation regulations 30, e.g. the exact format and data model of the configuration suited to the target plant, i.e. the components of the overall plant.

These target parameters 9 (FIG. 1) or this target configuration is now fed to a second configuration subtool 32, wherein the second configuration subtool 32 includes validation rules defined in advance and wherein by means of the validation rules, the target parameters 9 (FIG. 1) are validated. Therefore, the target configuration generated is validated here. In order to avoid combinations of machine configuration that are inconsistent or dangerous for goods and humans, the result generated must be validated. This step requires detailed validation rules that have been set in advance. At this point, evidence is provided by means of models and simulations that, for example, plant safety is assured. Herein, norms and guidelines of the respective plant operator play a role.

Now, this target configuration must be loaded onto the target plant. For this purpose, a network infrastructure is assumed, specifically a configuration connection 33 by means of which a secure and protected communication with the target plant is possible. The system proposed here must however be capable of adapting the machine-specific protocols and data exchange formats.

Subsequently, there follows a confirmation 34 by means of the target plant or those devices which now have the new target parameters 9 (FIG. 1). By means of a confirmation connection, the confirmation 34 of the adoption of the target parameters 9 (FIG. 1) is transmitted by the target plant. I.e., following adoption of the new configuration, the target plant confirms the procedure in such a manner that it can be reliably checked that the planned change has taken place successfully and has not been changed on the way. If all is in order, the new configuration flows back into the plant model 21. Thus the plant is up to date.

The present invention make it possible to use the findings obtained from the big data analyses for optimizing already installed devices and systems in the field without the need to exchange devices on site or having to accept long manual processes.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A system for controlling, monitoring and regulating a process in an industrial plant, comprising a closed feedback loop comprising:
an automatically configurable central data acquisition for acquiring an operating parameter generated by the industrial plant on a customer side in a field;
a central data evaluation unit including at least one centralized data collecting unit, at least one generating module configured to generate a result for plant optimization, process extension, optimization of necessary maintenance works, or any combination thereof, and at least one creation module configured to create a new target parameter via automated adaptation of the operating parameter;
a first communication connection for transmitting data from the field to the central data evaluation unit; and
a second communication connection for transmitting data in response to the target parameter from the central data evaluation unit back to the field and for adjusting the industrial plant as a function of the target parameter.

2. The system of claim 1, wherein the data collecting unit is configured as a big data collecting unit and/or at least one statistical data evaluation module.

3. The system of claim 1, wherein the data acquisition includes a data pre-compression.

4. The system of claim 1, wherein the data acquisition includes a data filtration.

5. The system of claim 1, wherein the first communication connection is provided at the customer or via the Internet.

6. The system of claim 1, wherein the creation module comprises a decision tool configured to generate a first decision concerning an automated or manual generation of a maintenance order for maintenance work, or to generate a second decision concerning an automated or manual generation of a modified target parameter, and further comprising a maintenance tool and a configuration tool which are provided downstream of the decision tool, with the first decision being fed to the maintenance tool and the second decision being fed to the configuration tool.

7. The system of claim 6, further comprising a plant model configured for automated or manual generation of the modified target parameter.

8. The system of claim 6, wherein the maintenance tool comprises at least one first subtool configured to generate the maintenance order, and a second maintenance subtool placed downstream of the first maintenance subtool configured to plan and issue the maintenance order.

9. The system of claim 6, wherein the configuration tool comprises at least one generation regulation for a plant machine in the industrial plant.

10. The system of claim 9, wherein the configuration tool comprises at least one first configuration subtool configured to generate the target parameter as a function of the generation regulation.

11. The system of claim 10, wherein the configuration tool comprises a second configuration subtool, said second configuration subtool configured to include a previously defined validation rule to enable validation of the target parameter.

12. The system of claim 11, wherein the configuration tool comprises a configuration connection for loading the validated target parameter into a target plant.

13. The system of claim 12, further comprising a confirmation connection configured to transmit a confirmation about an adoption of the target parameter by the target plant.

14. A method for operating a system for controlling, monitoring and regulating a process in an industrial plant, comprising establishing a closed feedback loop which comprises:
acquiring data via an automatically configurable central data acquisition of an operating parameter generated by the industrial plant on a customer side in a field;
connecting the field to a central data evaluation unit for transmitting data via a first communication connection;
collecting and evaluating the data in the central data evaluation unit via at least one centralized data collecting unit;
generating a result for plant optimization, process extension, optimization of necessary maintenance works, or any combination thereof, using at least one generating tool in the central data evaluation unit;
creating a new target parameter through automated adaptation of the operating parameter via at least one creation module in the central data evaluation unit; and
transmitting the new target parameter via a second communication connection from the central data evaluation unit back to the field for adjusting the industrial plant as a function of the target parameter.

15. The method of claim 14, wherein the creation module comprises a decision tool generating a first decision concerning an automated or manual generation of a maintenance order for maintenance work and transmitting the first decision to a maintenance tool downstream of the decision tool, or generating a second decision concerning an automated or manual generation of a modified target parameter and transmitting the second decision to a configuration tool downstream of the decision tool.

16. The method of claim 15, further comprising generating the maintenance order in at least one first maintenance subtool of the maintenance tool, and planning and issuing the maintenance order in a second maintenance subtool of the maintenance tool downstream of the first maintenance subtool.

17. The method of claim 15, wherein the target parameter is generated as a function of a generation regulation received by at least one first configuration subtool of the configuration tool.

18. The method of claim 17, further comprising providing a second configuration subtool of the configuration tool with a previously defined validation rule, and validating the target parameter as a function of the validation rule.

19. The method of claim 15, further comprising loading the validated target parameter into a target plant a configuration connection of the configuration tool, and transmitting a confirmation about an adoption of the target parameter by the target plant.
